(19) United States
(12) Patent Application Publication
(10) Pub. No.: US 2025/0269870 A1
(43) Pub. Date: Aug. 28, 2025

(54) Method for Operating a Vehicle

(71) Applicant: Robert Bosch GmbH, Stuttgart (DE)

(72) Inventor: Tobias Buchmann, Schwaebisch (DE)

(21) Appl. No.: 19/054,814

(22) Filed: Feb. 15, 2025

(30) Foreign Application Priority Data
Feb. 22, 2024 (DE) 10 2024 201 637.3

(51) Int. Cl. B60W 50/16; B60W 10/20; B60W 50/00; B60W 50/14

(52) U.S. Cl. CPC B60W 50/16; B60W 10/20; B60W 50/0098; B60W 2050/143; B60W 2050/146

(57) ABSTRACT

A method is disclosed for operating a vehicle with multi-actuator control system, in which the driving condition of the vehicle is monitored and, in the event that a borderline situation for the vehicle is detected, feedback is provided to the driver.

This application claims priority under 35 U.S.C. § 119 to patent application no. DE 10 2024 201 637.3, filed on Feb. 22, 2024 in Germany, the disclosure of which is incorporated herein by reference in its entirety.

The disclosure relates to a method for operating a vehicle, in particular a motor vehicle, and an arrangement for carrying out the method.

### BACKGROUND

A multi-actuator control system in a vehicle, in particular a motor vehicle, provides for simultaneous or coordinated control of brakes, steering, both front and rear axle steering, drive train and active chassis in order to increase driving stability and to improve comfort, energy efficiency and safety.

One disadvantage of such systems is that the vehicle still handles too well even at the physical limits, and an impending loss of control due to exceeding the physical limits may be noticed too late and then occurs all the more suddenly and unexpectedly.

Drivers tend to identify borderline situations as such too late. This can lead to dangerous situations arising, as corrective driver intervention may come too late.

Various controller concepts are known for the steering, which provide the driver with a smooth, comfortable steering feel, for example, or give increased road feedback. Combinations of the two concepts, for example depending on speed, are also known.

### SUMMARY

In this context, a method and an arrangement according to the description below are presented. Embodiments also arise from the description.

The presented method is used to operate a vehicle. The method involves monitoring the operating and driving conditions of the vehicle either continuously or at timed intervals. If the system detects that the vehicle is in a borderline situation, it will notify the driver. This feedback typically takes into account the nature and severity of the detected actual or impending borderline situation.

In one embodiment, the feedback is provided by influencing the controller concept of the steering.

A borderline situation, for example, is one in which assistance or foreseeable assistance for the driver through driving stabilization measures is detected.

The method is typically used in vehicles with multi-actuator control system for driving dynamics functions.

Multi-actuator control system means that at least two actuators of the vehicle, preferably from different subsystems of the vehicle, such as a steering actuator of a steering system and a brake actuator of a brake, are addressed simultaneously or in a coordinated manner.

With regard to multi-actuator control system, it should be noted that in classic vehicle architectures, different actuators, such as steering, brakes, active chassis or drivetrain, are controlled separately. The driver's operation of an actuator only has an immediate effect on that individual actuator. Interactions between the actuators are not taken into account at all or not to any great extent.

A multi-actuator control system coordinates the actions of the various actuators and adapts them to the situation. For example, the driver's request for a change of direction, triggered by a steering wheel movement, can be implemented not only by the control system of the steering actuator(s), but also by an additional braking intervention of individual wheels. This can enable a variety of new functions that, among other things, improve driving dynamics in borderline situations, increase driving comfort or support an economical driving style. The multi-actuator control system can be designed to be centralized or distributed.

In the prior art, the behavior of the multi-actuator control system depends on a variety of parameters, such as speed, acceleration or road conditions.

The method described provides for the driving experience to be influenced by driving stabilization measures in the event of increasing assistance and/or a foreseeable need for driver assistance in such a way that the driver is given noticeable feedback when entering or about to enter the borderline situation without having to accept disadvantages in vehicle handling. In particular, it is proposed that the steering feel be successively changed.

This can be done, for example, by switching between different steering controller concepts or by combining the weightings of different controllers with changing proportions to an overall result, typically depending on the strength of the support interventions.

If the control unit of the multi-actuator control system decides, for example, that the current driving situation requires a driving dynamics controller intervention, this can be indicated to the driver by increasing the weighting for a steering controller with a focus on road feedback compared to a steering controller with a focus on comfort perception. The severity of the required intervention by the driving dynamics controllers can be communicated to the steering, allowing a graduated feedback to be given to the driver. In addition, further tuning parameters for the steering feel can be enhanced to give the driver feedback on the upcoming borderline situation.

For example, predictive feedback can be provided by evaluating the current speed, the current road surface condition and the expected trajectory. The expected trajectory can be recorded via a camera, e.g. an upcoming bend, and specified via a programmed route in the navigation system, e.g. when there is an upcoming fork in the road.

If it is recognized that a borderline situation exists and/or that the current speed will lead to a borderline situation with the given road condition and trajectory, this can be communicated to the driver as feedback, e.g. by:
adjustment of the steering controller as described above,
display of visual or acoustic warnings, e.g. via head-up display (HUD),
feedback via an accelerator pedal, e.g. through vibration.

Furthermore, feedback to the driver can be provided in the following ways:
feedback can be provided, for example, by an active chassis or a semi-active suspension. When the driving dynamics controller intervenes, these are activated anyway if necessary to improve driving stability. In addition, the chassis and suspension can be optimized to provide the driver with better or stronger feedback on the road surface, thus sensitizing him to the controller intervention that is taking place or is imminent. Here, for example, other frequencies can be specifically influenced than is necessary for reasons of driving stability alone. This means that frequencies that would be adjusted for comfort reasons during normal driving can now be allowed.

In addition, the feedback can be provided by activating a reversible belt tensioner. Some of the systems currently in use already tighten the belt as a precaution, for example during heavy acceleration or braking. This can be supplemented by situations with an ongoing or imminent driving dynamics controller intervention.

Another option is to change the ventilation in a targeted manner, wherein cold air in particular is directed more towards the driver, e.g. onto the face and upper body.

Furthermore, if media playback is taking place, this can be done by reducing the volume of the media playback. The strength of the effect can be adjusted depending on the controller's level of intervention.

For all the above feedback contributions, it is possible and useful to regulate the strength of the effect depending on the degree of intervention of the driving dynamics controller. Depending on the strength of the driving dynamics intervention, gradual fading is possible, which should increase the perceived comfort. However, it is also possible to provide for hard gradations that are more noticeable. It is possible to provide the driver with a selection or setting option for the type and strength of the feedback elements, as well as the input and output phase behavior.

The individual measures or contributions listed above can be combined in any way or can also be implemented step by step or in a complementary manner in the sense of an escalation with increasing intervention strength of the driving dynamics controller.

The method presented can be used to prevent inexperienced drivers in particular from being lulled into a false sense of security by advanced assistance systems, such as multi-actuator driving dynamics controllers, and unwittingly approaching the physical borderline situation. This makes the use of multi-actuator driving dynamics controllers safer and easier for the end user to manage. This helps to reduce the risk of accidents.

It is particularly noteworthy that the steering feel and other feedback options, such as pedals, HUD, etc., are dynamically adjusted depending on the driving dynamics controller interventions that are taking place or are imminent, in order to provide the driver with feedback on the driving situation.

The method can be used on all vehicles with systems for multi-actuator control system for driving dynamics controller. To a certain extent, it can also be used in conventional driving dynamics controllers.

The arrangement presented is set up to carry out a method of the type described herein and typically has an evaluation unit for this purpose, which in turn is designed to recognize a borderline situation, whether it exists or is imminent, by evaluating data or information describing the driving conditions. The arrangement or the evaluation unit can then determine and trigger a suitable feedback to the driver by regularly detecting and outputting at least one control signal for at least one actuator and/or a human-machine interface, such as a loudspeaker or a display.

The arrangement can also be implemented in hardware and/or software and can also be integrated into a control unit of the vehicle or designed as such a control unit.

Further advantages and embodiments of the disclosure are shown in the description and the accompanying drawings.

It is understood that the abovementioned features and those to be explained below can be used not only in the combination indicated in each case, but also in other combinations or on their own, without departing from the scope of the present disclosure.

### BRIEF DESCRIPTION OF THE DRAWINGS

FIG. 1 shows a flow chart of a possible sequence of the presented method.

FIG. 2 shows a schematic, highly simplified representation of a vehicle with an embodiment of the described arrangement for carrying out the presented method.

### DETAILED DESCRIPTION

The disclosure is illustrated schematically by way of embodiments in the drawings and is described in detail below with reference to the drawings.

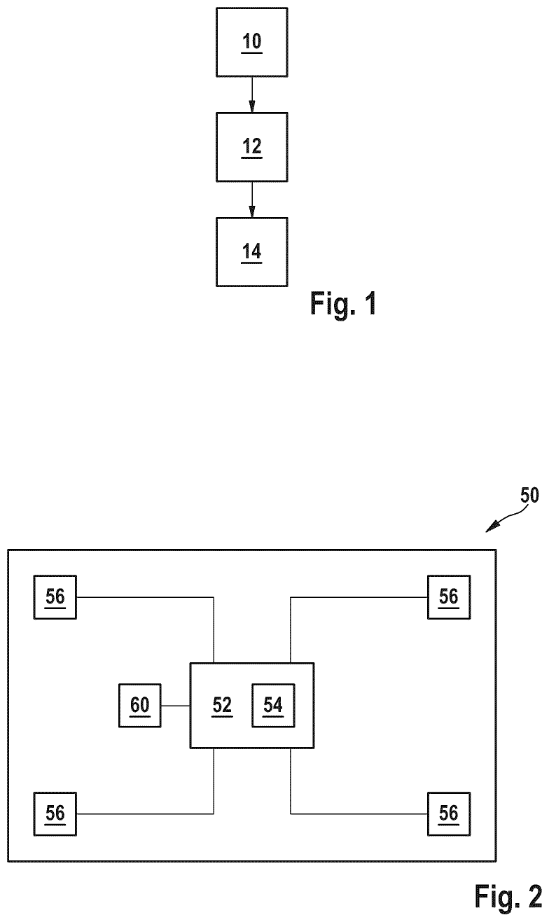

FIG. 1 shows a flow chart of a possible sequence of the presented method. In the first step 10, a vehicle begins its journey, and its driving conditions is monitored either continuously or at intervals. Whether continuous monitoring or monitoring at time intervals is carried out, as well as the time interval between monitoring, can be determined by the driver and/or depend on external circumstances or conditions.

In the next step, 12, it is recognized that a borderline situation is imminent and then, in a subsequent step 14, a measure is initiated that provides feedback to the driver. This feedback can be provided by one or more feedback measures.

FIG. 2 shows a schematic, highly simplified representation of a vehicle, which is labeled with the reference number 50. Furthermore, the illustration shows an arrangement 52 for carrying out the described method, in which an evaluation unit 54 is also provided.

The vehicle 50 is configured for multi-actuator operation, therefore, a plurality of actuators 56 are provided for acting on the operation of the vehicle 50. Information and data on the driving conditions are recorded and evaluated by the arrangement 52 and the evaluation unit 54 in the arrangement. If a critical condition for operation is detected, which may be present or imminent, the arrangement 52 or the evaluation unit 54 triggers a feedback 60 to the driver of the vehicle 50.

What is claimed is:

1. A method for operating a vehicle with a multi-actuator control system, comprising:
(a) monitoring a driving condition of the vehicle; and
(b) providing feedback to a driver if a borderline situation for the vehicle is detected.

2. The method according to claim 1, wherein step (b) includes influencing a steering controller concept of the vehicle.

3. The method according to claim 1, wherein step (b) includes providing feedback to the driver when an impending borderline situation is detected.

4. The method according to claim 1, wherein step (b) includes providing feedback to the driver when an existing borderline situation is recognized.

5. The method according to claim 1, wherein a situation in which the driver is assisted or can be foreseen to be assisted by measures which stabilize the driving is recognized as the borderline situation.

6. The method according to claim 1, wherein the feedback is selected from a group of feedback measures consisting of: control system of an active chassis, control system of a semi-active suspension, control system of a reversible seat belt tensioner, control system of ventilation, influencing a volume of media playback, playback on a display.

7. The method according to claim 6, wherein the feedback measures are given as supplementary and/or successive feedback.

8. The method according to claim 6, wherein the feedback measures are given in successive and/or supplementary steps as feedback.

9. An arrangement for operating a vehicle comprising an evaluation unit which is set up to carry out a method according to claim 1.

10. The arrangement according to claim 9, wherein the arrangement is designed for use in a vehicle with the multi-actuator control system.
